(19) United States
(12) Patent Application Publication
(10) Pub. No.: US 2025/0216950 A1
(43) Pub. Date: Jul. 3, 2025

(54) METHOD FOR ACHIEVING TYPING OR TOUCH CONTROL WITH TACTILE FEEDBACK

(71) Applicant: JONG-GUANG PAN, Liaoning Province (CN)

(72) Inventor: JONG-GUANG PAN, Liaoning Province (CN)

(21) Appl. No.: 18/916,756

(22) Filed: Oct. 16, 2024

(30) Foreign Application Priority Data
Dec. 27, 2023 (CN) 202311811248.1

(51) Int. Cl. G06F 3/01; G06F 3/042; G06F 3/04886; G06T 7/246; G06T 7/285; G06V 40/10; G06V 40/20

(52) U.S. Cl. CPC G06F 3/017; G06F 3/011; G06F 3/042; G06F 3/04886; G06T 7/251; G06T 7/285; G06V 40/28; G06F 2203/04803; G06T 2207/10021; G06T 2207/30196; G06V 40/10

(57) ABSTRACT

A method in XR technology to determine whether an actual touch of a function region during virtual typing or touch control performed on the palm or on a real object is achieved, by marking preset points on the palm; assigning a function region to each preset point; setting two trigger determination points WL and WR; acquiring N number of video streams with parallax; tracking and determining whether a trigger fingertip P is located between the two trigger determination points in all corresponding N number of images bearing a same time from the N number of video streams; in each of the N number of images, calculate a ratio being a difference in X-axis value between P and WR to a difference in X-axis value between WL and P; only when all ratios in all images are the same, the trigger fingertip P is determined to have touched the function region.

### TECHNICAL FIELD

The present invention relates to the fields of virtual keyboards and touch control technologies, and particularly relates to a method for achieving typing or touch control with tactile feedback applicable to an extended reality (XR) wearable device or particularly an extended reality headset.

### BACKGROUND OF THE INVENTION

Extended reality (XR) refers to an environment of combined reality and virtuality allowing human-machine interaction realized by computer technologies and human wearable devices, and it is a general term encapsulating augmented reality (AR), virtual reality (VR), and mixed reality (MR). With the popularization and development of XR in various industries, various XR glasses have emerged, which achieve interaction between a user and a system by inputs through a virtual keyboard and touch control.

At present, there are two types of virtual keyboards and touch controls: (1) a virtual keyboard anchored in a three-dimensional environment of 1/3/6 degrees of freedom (1/3/6DoF), where typing or touch control is performed in the air by both hands, and positions of fingertips or rays are calculated by using a joint recognition model to determine whether threshold positions of virtual keys have been touched or not; and (2) virtual keys assigned on a palm and fingers, where a tip (or any part that can be focused as a cursor point) of a thumb (or any finger) is generally defined as the “trigger fingertip”, and the virtual keys are assigned to three phalangeal joints of each of other fingers and/or different regions of the palm, and the virtual keys are defined to correspond to different number keys, letter keys, or function keys respectively, and a human hand joint detection model is used to determine whether the trigger fingertip touches threshold positions of the virtual keys.

The first type of virtual keyboard as mentioned above (which enables different functions like key pressing, link access and computer drawings, of which the relevant sections of the virtual keyboard realizing these functions are collectively referred to as “function regions” hereinafter) has an input method similar to that of tapping a conventional keyboard and triggering a cursor pointer, but there are two problems: (a) as the function regions are often blocked by the back sides of the hands and by the fingers, it is difficult to determine whether an unseen trigger fingertip actually touches a threshold position of a certain function region during visual detection and calculation; and (b) tactile feedback of using a physical keyboard is lacking during use, and the user can only determine whether a trigger fingertip touches a correct character key by user's own visual determination when typing in the air, therefore it is impossible to realize blind typing/touch typing.

The second type of virtual keyboard triggering the function regions in the palm and fingers is similar to gesturing the fingers in various ways as in traditional Chinese Taoism. The function regions are assigned to visible and detectable palms and fingers. As the palms (for simplicity, the term “palm” used in this specification starting from here refers to all portions of the palm including the fingers where detection and determination are required, and the portion of the “palm” without the fingers is specifically referred as “palm center”.) face towards a camera of the XR glasses during input, and the trigger fingertips are used to touch the function regions on the palms to trigger the input, the problems of tactile feedback and blocking by the back sides of the hands can be solved. However, the problem that the trigger fingertips visually blocking the function regions is still present. When a trigger fingertip is positioned over a certain function region, it cannot be determined by visual detection and calculation whether the trigger fingertip touches the function region or whether it is still distanced from the function region in an untouched state; accordingly, the trigger fingertip can be inaccurately determined to be touching the corresponding function region and thus a function of that function region can be mistakenly triggered. In order to solve the problem of uncertain determination of touch by visual detection and calculation or gesture recognition model, many patents have tried to accurately determine whether a trigger fingertip actually touches a certain function region through sensor rings or sensor gloves. However, wearing sensors in form of gloves or rings provides bad user's experience and poor practicability since users usually do not want to wear any devices or sensors during use.

### BRIEF SUMMARY OF THE INVENTION

The present invention aims to solve the problem of inaccurate determination of whether a virtual key is touched or not in the existing gesture recognition and visual calculation technologies by providing a method for achieving typing or touch control with tactile feedback. The present invention can accurately confirm whether a trigger fingertip actually touches a function region simply by calculation performed on visual images captured by cameras without using any physical auxiliary devices such as sensors, and less calculation is needed by the present invention. In addition, as the trigger fingertip touches a palm or an object surface, instead of gesturing in the air without any tactile feedback, tactile sensation is achieved during typing or touch control, thereby achieving better user's experience and enabling blind typing/touch typing.

The present invention discloses a method for achieving typing or touch control with tactile feedback, implemented through a system configured in an extended reality (XR) wearable device or an extended reality headset; wherein the system outputs positional information, which bears a time sequence, of joint points of a human hand captured in a video stream of each camera of the system through a human hand joint detection model; typing and touch control is achieved through a trigger fingertip touching function regions assigned virtually on a palm of the human hand, wherein the palm is defined to include both a palm center without fingers, and also the fingers; each of the function regions is a character or number button, function key, or shortcut key that is capable of being triggered; and a corresponding function region is assigned and fixed to a preset point marked on a virtual joint line of each of every two adjacent joints of the palm; said method is characterized by comprising the following steps:
Step 1: mark the preset point on the virtual joint line of each of every two adjacent joints of the palm, wherein the corresponding function region assigned to each preset point on the palm is capable of being visually perceived through a pair of intelligent glasses; set a width of each of the function regions as W; a corresponding preset point of each of the function regions is determined as a central point of that function region; set a left trigger determination point WL and a right trigger determination point WR at positions W/2 to the left and W/2 to the right of the central point of each of the function regions respectively along a direction parallel to an X-axis; determine the positional information of each preset point and the left trigger determination point WL and the right trigger determination point WR of the corresponding function region assigned to each preset point based on the joint points;
Step 2: consider by default a tip of a thumb to be the trigger fingertip; if the thumb does not access to areas on the palm, but a tip of any one of other fingers is intended to touch the palm and the function regions assigned to the palm, the tip of said any one of other fingers is determined as the trigger fingertip; the trigger fingertip is identified as P;
Step 3, the system acquires N number of video streams with parallax from at least two cameras, wherein N is an integer, and N≥2, track and determine whether the trigger fingertip P is located between the left trigger determination point WL and the right trigger determination point WR corresponding to left and right sides of a corresponding function region respectively in all corresponding N number of images bearing a same time from said N number of video streams respectively, and if yes, calculate the positional information of three target points T which are the left trigger determination point WL, the trigger fingertip P, and the right trigger determination point WR for each of said N number of images bearing the same time; then in each of said N number of images bearing the same time, X-axis values (WRX, PX, and WLX) of the positional information of the three target points T in that image are used to calculate a ratio (PX−WRX):(WLX−PX) which is a difference in value between PX and WRX to a difference in value between WLX and PX; only when all ratios calculated in all of said N number of images bearing the same time are the same, the trigger fingertip P is determined to have touched the corresponding function region, and then a function corresponding to the corresponding function region is outputted or triggered.

In the above Step 3, said at least two cameras comprises two cameras being a left camera and a right camera; treating a connecting line passing through two central points L and R of the left camera and the right camera respectively as an X-axis; assuming that in a field of vision of the left camera, an included angle defined as T is formed between the X-axis and a connecting line connecting the central point L of the left camera and one of the three target points T; assuming that in a field of vision of the right camera, an included angle defined as TθR is formed between the X-axis and a connecting line connecting the central point R of the right camera and one of the three target points T; assuming a length of a parallax baseline between the two central points L and R of the left camera and the right camera as d; calculate a position (X, Z) of any one of the three target points T in each of said N number of images bearing the same time based on the following:

If the target point T whose position is to be calculated is located between the two central points L and R of the left camera and the right camera:

$$Z = d / [ TAN ( T θ L ) - TAN ( T θ R - π / 2 ) ] , X = Z * TAN ( T θ L ) ;$$

If the target point T whose position is to be calculated is located on a left side of the central point L of the left camera:

$$Z = d / [ TAN ( T θ R - π / 2 ) - TAN ( T θ L - π / 2 ) ] , X = - Z * TAN ( T θ L ) ;$$

If the target point T whose position is to be calculated is located on a right side of the central point R of the right camera:

$$Z = d / [ COT ( T θ L ) - COT ( T θ R ) ] , X = Z / Tan ( T θ L ) .$$

Each of the function regions has a circular shape; a circle is drawn for each of the function regions with the preset point set at any position on the joint line between each of every two adjacent joints of the palm as a center of circle and the width W of each of the function regions as a diameter.

Each of the function regions is assigned within a phalangeal region, between two phalangeal regions, on an outer side of the phalangeal region, or at a certain area of the palm center between a wrist and a certain finger.

In the above Step 3, the system virtually assigns a matrix grid to a same position on the palm center when N number of video streams are processed, wherein N is an integer, and E the matrix grid comprises a plurality of grid units each having a plurality of sides, and each grid unit is considered as one function region; the system tracks and determines whether the trigger fingertip P (X, Y) is located in a same function region of the matrix grid in all of said N number of viewer's screens, and if yes, the trigger fingertip P (X, Y) and the left trigger determination point WL and the right trigger determination point WR to left and right sides of the function region in concern are determined as the three target points T; then X-axis values (WRX, PX, and WLX) of the positional information of the three target points are used to calculate a ratio (PX−WRX):(WLX−PX) which is a difference in value between PX and WRX to a difference in value between WLX and PX; if ratios calculated in all corresponding images bearing a same time in said N number of viewer's screens are equal, the trigger fingertip P is determined to have touched the function region, and so a point or stroke is drawn corresponding to a position of the trigger fingertip P (X, Y), and as the trigger fingertip P moves, series of determinations by the system through time bearing a time sequence will determine points or strokes successively drawn in successive locations through time and thus determine that a line is drawn where all points or strokes being drawn are determined to be joined together; therefore, functions of tablet control or touch control can be implemented in the palm of one hand by using one fingertip of another hand as the trigger fingertip.

A connection point between a little finger and the palm center is determined as an upper right corner of the matrix grid; a connection point of an index finger and the palm center is determined as an upper left corner of the matrix grid; and a connection line between the palm center and a wrist is determined as a bottom edge of the matrix grid.

The matrix grid is invisible and not displayed on said N number of viewer's screens.

Each grid unit has a square or rectangular shape.

The present invention also discloses another method for achieving typing or touch control with tactile feedback, implemented through a system configured in an extended reality (XR) wearable device or an extended reality headset; the system outputs positional information, bearing a time sequence, of target points captured by videos; typing and touch control is achieved by a trigger fingertip touching function regions; said method comprises the following steps:
Step 1, the system anchors a touch control interface image on each viewer's screen at a same position of a same preset object surface; a plurality of said function regions are assigned on the touch control interface image as viewed from any one of the N number of viewer's screens; corresponding images from all the videos bearing a same time are each being determined to have a left trigger determination point WL and a right trigger determination point WR at left and right sides of a corresponding function region in concern respectively along a direction parallel to an X-axis of the image from a corresponding video;
Step 2, a tip of any finger intended to touch the function regions is determined as the trigger fingertip;
Step 3, the system acquires N number of video streams with parallax, where N is an integer, and N≤2; track and determine whether the trigger fingertip P (X, Y) is located in a same function region in all corresponding N number of images bearing a same time from said N number of video streams respectively, and if yes, the trigger fingertip P (X, Y) and the left trigger determination point WL and the right trigger determination point WR corresponding to the function region in concern are used as three target points; X-axis values (WRX, PX, and WLX) in the positional information of the three target points T are used to calculate a ratio (PX−WRX):(WLX−PX) which is a difference in value between PX and WRX to a difference in value between WLX and PX; only when all ratios in said N number of images bearing the same time are the same, the trigger fingertip P is determined to have touched the function region, and then a function corresponding to the function region is outputted or triggered.

The touch control interface image is an image of a conventional numeric pad or a conventional keyboard.

The preset object surface is any surface of a real object.

The preset object surface is a surface of a virtual object, and when the trigger fingertip touches a corresponding function region, feedback in form of sound, vibration, electric shock, or other mechanical feedback is provided to create a sense of touching a real object.

A head-mounted display device, comprising at least two cameras configured to take videos or images of a targeted region; the head-mounted display device also comprises a memory and a processor; the memory is configured to store a computer program; the processor executes the computer program to perform any one of the above described methods.

According to the technical solutions provided by the present invention, video streams with parallax are captured by at least two cameras of a pair of intelligent glasses respectively, and corresponding images from all the video streams having a same time will be used for determination of whether a function region is being touched or not, wherein a connecting line passing through the central point of said at least two cameras is considered an X-axis or to be parallel to an X-axis, the trigger fingertip P and the left trigger determination point WL and the right trigger determination point WR of the function region which the trigger fingertip P intends to touch are considered as the three target points T, and the X-axis values of the positional information of the three target points T are being used to calculate the ratio (PX−WRX):(WLX−PX) which is a difference in value between PX and WRX to a difference in value between WLX and PX; only when all ratios in N number of images bearing the same time are the same, the trigger fingertip P is determined to have touched the function region. Accordingly, the formulae determining a depth Z of a spatial position of any one of the target points to be calculated in a field of view of each camera can omit the Y-axis from calculation. Since a distance defined by the parallax baseline between every two adjacent cameras is fixed, a distance defined by the parallax baseline between two eyes of a viewer is unchanged, so that when the trigger fingertip performs an actual touch of a function region, both the left eye and the right eye of the viewer will perceive a same relative position of the trigger fingertip on or along the X-axis of the function region, more specifically, when three target points are on a same line, relative positioning between the three target points will be the same no matter if being viewed from different angles from the left and right (or even more) cameras. Thus, it is proven that it is not necessary to know an exact value for depth Z before determination of whether the trigger fingertip has touched the function region, and value d which is a distance of the parallax baseline between two cameras can be any value during calculation. In the present invention, the touch control tolerance is Z, a, where Z is a depth between a target point and a corresponding camera, d is a distance of parallax baseline between two cameras, and a is a threshold value. According to the present invention, in the field of view of the intelligent glasses, whether the trigger fingertip has in fact touched a function region is determined by the relative positional relationship of the trigger fingertip with respect to the two trigger determination points on the left and right sides of the function region respectively in each of all corresponding images bearing the same time of all video streams captured by the cameras, and if the relative positional relationships determined in all corresponding images bearing the same time are the same, the trigger fingertip is determined to have touched the function region, otherwise, it is determined that no touch is performed, therefore, the exact values of X, Y, Z and d are not required to be known prior to determination; only the X-axis pixel value of each of the N number of cameras is required. The present invention solves the problem of inaccurate determination of whether a virtual key is touched or not in the existing gesture recognition and visual calculation technologies by providing a method for achieving virtual typing or touch control with tactile feedback.

Since the present invention does not need to know the exact value of depth Z of the trigger fingertip prior to the determination of whether the trigger fingertip has touched the function region, the present invention may also anchor a matrix grid virtually on a palm center, and treat each grid unit as a function region. At least two video streams are captured by at least two cameras of a pair of intelligent glasses respectively corresponding to at least a left eye and a right eye of the user, and a parallax baseline of distance d exists between said at least two cameras. Determine a relative positional relationship between the trigger fingertip P (X,Y) and two trigger determination points of a grid unit corresponding to same height Y where the trigger fingertip P is positioned in each of all corresponding images from said at least two video streams bearing a same time; if the relative positional relationship of the three target points is the same in all said corresponding images from said at least two video streams bearing the same time, it is determined that the trigger fingertip has touched the corresponding function region, otherwise, it is determined that no touch is achieved. In case a successful touch is determined, a point or stroke is drawn corresponding to a position of the trigger fingertip P (X,Y), and as the trigger fingertip P moves, series of determinations through time bearing a time sequence will determine points or strokes successively drawn in successive locations through time and thus determine that a line is drawn where all points or strokes being drawn are determined to be joined together. Therefore, the functions of drawing, writing, and dragging can be implemented in the palm of one hand by using one fingertip of another hand as the trigger fingertip, just like implementing touch control function on a tablet or a touch screen. Further, the touch control function of a tablet or a touch screen with multiple fingers may also be implemented by using multiple trigger fingertips. Also, a three-dimensional point or stroke P (X, Y, Z) may also be drawn by calculating a depth Z of the trigger fingertip by trigonometry.

Apart from anchoring numeric pad, keyboard and drawing pad virtually on the palm, the present invention also enables virtual typing and touch control outside the palm. Specifically, the intelligent glasses can project a simple numeric pad or a keyboard image on a certain object surface like a wall surface or a table surface, or any surface of other real or virtual object, and the object surface may not be a planar surface but an undulating surface. At least two video streams having a parallax are captured by at least two cameras of the intelligent glasses respectively; when the trigger fingertip accesses a function region of the projected image, a relative positional relationship between the trigger fingertip and two trigger determination points of the corresponding function region is determined in each of all corresponding images bearing a same time from said at least two video streams; if the positional relationship of the three target points are the same in all the corresponding images bearing the same time, it is determined that the trigger fingertip has touched the function region; otherwise, it is determined that no touch is achieved. Accordingly, user can perform typing or touch control on a real object surface instead of typing or controlling virtual keys projected in the air, thereby providing tactile feedback during typing or touch control.

### BRIEF DESCRIPTION OF THE DRAWINGS

FIG. 1 shows 21 recognizable joint points of a human hand and numeric identifiers thereof given by the Mediapipe official website;

FIG. 2 is a schematic diagram of calculating a spatial position of a target point T through a left camera of a pair of intelligent glasses according to the present invention;

FIG. 3 is a schematic diagram of calculating a spatial position of a target point T through a right camera of the pair of intelligent glasses according to the present invention;

FIG. 4 are schematic illustrations of a function region W disposed on a palm when the palm is in different orientations according to the present invention;

FIG. 5 is a combined image from a left camera and a right camera showing relative positioning of the trigger fingertip and the two trigger determination points when the trigger fingertip does not touch a function region;

FIG. 6 is a combined image from a left camera and a right camera showing relative positioning of the trigger fingertip and the two trigger determination points when the trigger fingertip touches a function region;

FIG. 7 illustrate four separate images showing relative positioning of the trigger fingertip and the two trigger determination points, where the upper two images show images from the left camera and the right camera respectively when the trigger fingertip does not touch a function region, and the lower two images show images from the left camera and the right camera respectively when the trigger fingertip touches a function region;

FIG. 8 is a schematic diagram of an arrangement of function regions in form of a numeric pad on one hand according to the present invention;

FIG. 9 is a schematic diagram of an arrangement of function regions of a conventional QWERTY keyboard on both hands according to the present invention;

FIG. 10 is a schematic diagram of triggering a function region at a tip end of an index finger by a trigger fingertip according to the present invention;

FIG. 11 is a schematic diagram of triggering a function region at a distal phalangeal region of an index finger by a trigger fingertip according to the present invention;

FIG. 12 is a schematic diagram of triggering a function region at a middle phalangeal region of an index finger by a trigger fingertip according to the present invention;

FIG. 13 is a schematic diagram of triggering a function region at a proximal phalangeal region of an index finger by a trigger fingertip according to the present invention;

FIG. 14 is a schematic diagram of triggering a function region at a lower end of the proximal phalangeal region of an index finger by a trigger fingertip according to the present invention;

FIG. 15 is a schematic diagram of triggering a function region at a position of a palm close to the wrist by a tip of an index finger serving as a trigger fingertip according to the present invention;

FIG. 16 is a structural block diagram of a head-mounted display device according to the present invention;

FIG. 17 is a schematic diagram of an XY matrix grid assigned to a palm center for implementing touch control functions of dragging, writing, and drawing on the palm according to the present invention;

FIG. 18 is a schematic diagram of an XY matrix grid assigned to a palm center and shortcut keys assigned to phalangeal regions according to the present invention;

FIG. 19 is an image of a numeric pad anchored to any object surface in a three-dimensional environment of 1/3/6DoF according to the present invention; and

FIG. 20 is an image of a keyboard anchored to any object surface in a three-dimensional environment of 1/3/6DoF according to the present invention.

### DETAILED DESCRIPTION OF THE INVENTION

The technical solutions in the embodiments of the present application will be clearly and thoroughly described below with reference to the accompanying drawings of the embodiments of the present application. It is obvious that the described embodiments illustrate only some but not all of the embodiments of the present application. Based on the embodiments of the present application, all other embodiments obtainable by those of ordinary skills in the art without any need of inventive effort shall fall within the protection scope of the present application.

Moreover, the terms “comprise” and “include” and any variations thereof are intended to be an non-exclusive inclusion. For example, a process, method, system, product, or server including a series of steps or units is not necessarily limited to the explicitly listed steps or units, but may include other steps or units that are not explicitly listed or are known to such process, method, product, or device.

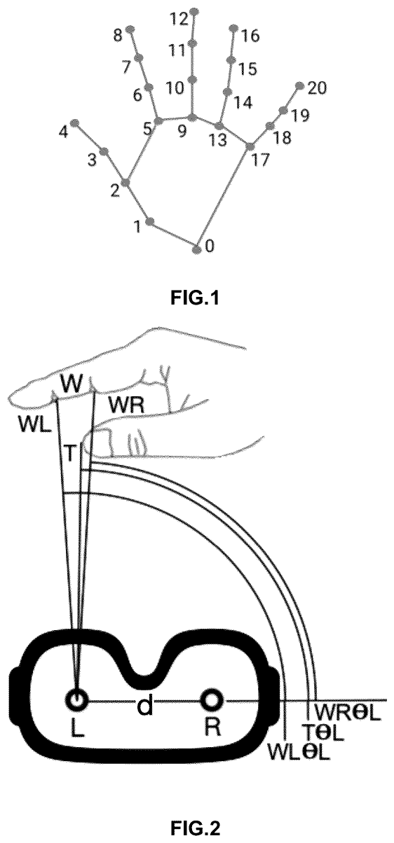

The principles of the technical solutions of the present invention are as follows:
(1) Recognition model used to acquire positional information on a palm: an open source software currently available in the market for a pre-trained human hand joint detection model that can acquire two dimensional positions of human hand joints can be used. The present invention uses Mediapipe as an illustrative example. As an open source project of Google, Mediapipe is a tool library for machine learning which mainly pertains to visual algorithms, and integrates a large sum of models relating to face detection, face key points, gesture recognition, head segmentation, and posture recognition. As shown in FIG. 1, positional information of 21 joint points (also referred to as key points) of a human hand in a video bearing a time sequence can be outputted. Generally, a human hand joint detection model outputs joint positional information in form of (X, Y) pixels being coordinates of an X-axis and a Y-axis of the video. The present invention can also use a self-trained human hand joint detection model. The present invention also comprises learning to recognize whether a trigger fingertip is located in a function region by using an artificial intelligence chip such as a graphics processing unit (GPU) or a neural network processing unit (NPU) through label convolution KNN or RNN or through a Transformer model plus pre-training methods.
(2) Setting of the function regions on the palm: The positional information of the 21 joint points (also referred to as key points) of a human hand in a video in form of (X, Y) pixels bearing a time sequence can be outputted by using the existing human hand joint detection model. The present invention marks a preset point on a joint line of each of every two adjacent joints of the palm (said preset point can be a middle point of the joint line). The user can see a corresponding function region assigned to each preset point on the palm through a pair of intelligent glasses, and each function region can be a character button, function key, or shortcut key that can be triggered. A width of each function region is set as W, a corresponding preset point of each function region is determined as a central point of that function region, and two trigger determination points WL and WR are set at positions W/2 to the left and W/2 to the right of the central point respectively along a direction parallel to the X-axis. The positional information of each preset point and the two trigger determination points WL and WR of the function region assigned to each preset point can be determined based on the joint points. Each function region may be of any shape. Preferably, each function region has a circular shape, because the display effect of the function region on the palm is not affected regardless of the rotation of the palm. A circular function region is shown in FIG. 4, where a circle is drawn with a preset point set at any position on the joint line between two adjacent joints as a center of circle and width W of the function region as a diameter. The present invention can assign each function region within a phalangeal region, between two phalangeal regions, on an outer side of a phalangeal region, or at a certain area of the palm center between the wrist and a certain finger.
(3) Setting of the trigger fingertip: A tip of a thumb serves as the trigger fingertip by default. If the thumb does not access to areas on the palm or if the tip of the thumb does not serve as the trigger fingertip, a tip of any one of other fingers intended to touch the palm and the function regions assigned to the palm will be determined as the trigger fingertip.

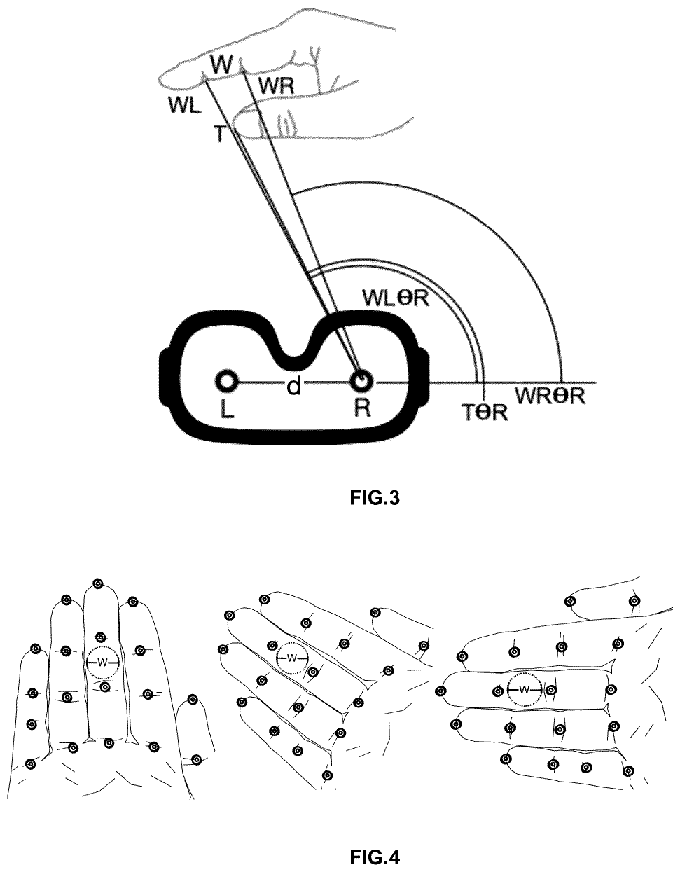

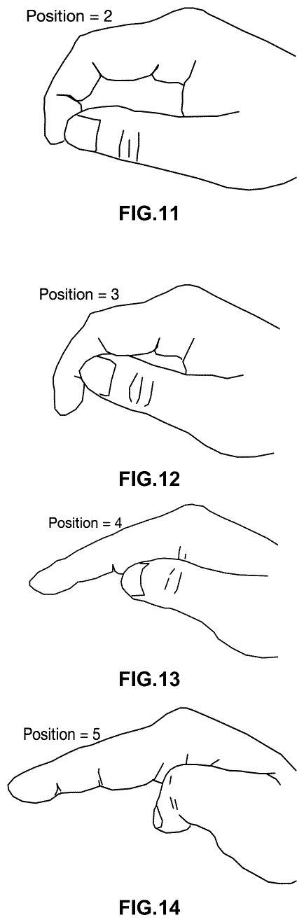

An illustrative example of an arrangement of the function regions on a palm in form of a numeric pad is shown in FIG. 8. Also with reference to FIG. 10, when the trigger fingertip touches any one of the function regions on a tip end of any one of the other fingers, a character “C” corresponding to the index finger, a symbol “/” corresponding to the middle finger, a character “X” corresponding to the ring finger, or a function key “delete” corresponding to the little finger will be triggered. As shown in FIG. 11, when the trigger fingertip touches any one of the function region at a distal phalangeal region of any one of the other fingers, a character “1” corresponding to the index finger, a character “2” corresponding to the middle finger, a character “3” corresponding to the ring finger, or a symbol “−” corresponding to the little finger will be triggered. As shown in FIG. 12, when the trigger fingertip touches any one of the function regions at a middle phalangeal region of any one of the other fingers, a character “4” corresponding to the index finger, a character “5” corresponding to the middle finger, a character “6” corresponding to the ring finger, or a symbol “+” corresponding to the little finger will be triggered. As shown in FIG. 13, when the trigger fingertip touches any one of the function regions at a proximal phalangeal region of any one of the other fingers, a character “7” corresponding to the index finger, a character “8” corresponding to the middle finger, a character “9” corresponding to the ring finger, or a symbol “=” corresponding to the little finger will be triggered. As shown in FIG. 14, when the trigger fingertip touches any one of the function regions at a lower end of the proximal phalangeal region of any one of the other fingers, a symbol “%” corresponding to the index finger, a character “0” corresponding to the middle finger, a symbol “.” corresponding to the ring finger, and a symbol “=” corresponding to the little finger will be triggered. It can be seen that if the function regions are assigned at tops (tip ends) of the fingertips, at different phalangeal regions, or at positions on the palm center close to corresponding phalangeal regions, the function regions can be triggered when the thumb serves as the trigger fingertip to touch the function regions. However, the thumb cannot easily touch the function regions assigned at positions on the palm center close to the wrist. Therefore, the present invention will assign corresponding fingers to trigger these function regions, in which the trigger fingertips are the fingertips corresponding to said assigned corresponding fingers instead of the tip of the thumb, such that the corresponding function regions can be triggered to output characters/functions by touching the corresponding function regions with the fingertips of said assigned corresponding fingers. As shown in FIGS. 8 and 15, a function key “MC” can be triggered by the index finger, a function key “M+” can be triggered by the middle finger, a function key “M−” can be triggered by the ring finger, and the function key “MR” can be triggered by the little finger.
(4) Calculation of a spatial position of a target point: Although XR intelligent glasses enable a vision of a three-dimensional (X-axis, Y-axis, and Z-axis) space, the Y-axis can in fact be omitted from consideration when calculating positions of the trigger fingertip and the left and right trigger determination points along the X-axis direction of the function regions, so that calculation is simplified to a two-dimensional position calculation. As shown in FIG. 2, treating a connecting line passing through central points L/R of both left and right cameras of the XR intelligent glasses as an X-axis, and with reference to FIG. 2 again where a field of vision of the left camera is shown, an included angle defined as TθL is formed between the X-axis and a connecting line connecting the central point L of the left camera and a target point T whose spatial position is yet to be calculated; specifically, an included angle between the X-axis and a connecting line connecting the central point L of the left camera and the trigger determination point WL is defined as WLθL, an included angle between the X-axis and a connecting line connecting the central point L of the left camera and the trigger determination point WR is defined as WRθL; similarly, as shown in FIG. 3 where a field of vision of the right camera is shown, an included angle defined as TθR is formed between the X-axis and a connecting line connecting the central point R of the right camera and a target point T whose spatial position is yet to be calculated; specifically, an included angle between the X-axis and a connecting line connecting the central point R of the right camera and the trigger determination point WL is defined as WLθR, an included angle between the X-axis and a connecting line connecting the central point R of the right camera and the trigger determination point WR is defined as
WRθR, and an included angle between the X-axis and a connecting line connecting the central point R of the right camera and the trigger fingertip T is defined as TR.

The trigger fingertip P, and the left and right trigger determination points WL and WR are three target points T whose spatial positions are to be calculated. A length of a parallax baseline between the two central points L and R of the left and right cameras is assumed as d. A position (X, Z) of any target point T can be calculated based on the following:

If the target point T is located between the two central points L and R of the left and right cameras:

$$Z = d / [ TAN ( T θ L ) - TAN ( T θ R - π / 2 ) ] , X = Z * TAN ( T θ L ) .$$

If the target point T is located on a left side of the central point L of the left camera:

$$Z = d / [ TAN ( T θ R - π / 2 ) - TAN ( T θ L - π / 2 ) ] , X = - Z * TAN ( T θ L ) .$$

If the target point T is located on a right side of the central point R of the right camera:

$$Z = d / [ COT ( T θ L ) - COT ( T θ R ) ] , X = Z / Tan ( T θ L ) .$$

The above examples are calculated by using TAN and COT, but any other trigonometric calculation methods can be used by the present invention.
(5) Method for determining whether the trigger fingertip touches the function region:

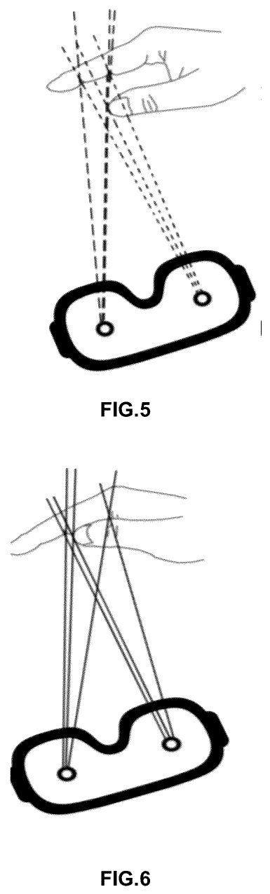

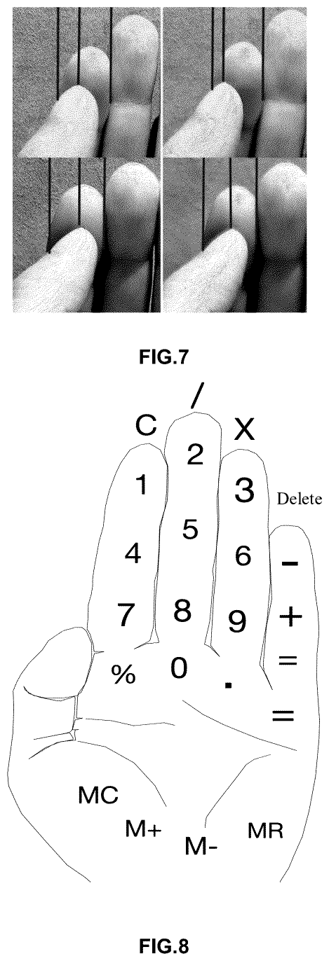

A system of the present invention acquires video streams from the left and right cameras (or from more than these two angles) having parallax, and then performs determination on a left image and a right image (or a plurality of images in case of more than these two images) corresponding to a same time in the video streams from the left and right cameras (or from more than these two angles) respectively. If the trigger fingertip P is located between two trigger determination points WL and WR of any function region, a radian ratio (PθL−WRθL):(WLθL−PθL) of the left image is compared with a radian ratio (PθL−WRθR):(WLθR−PθL) of the right image. If the two ratios are not equal, the trigger fingertip is determined to be not touching the function region, as shown in FIG. 5 and the two upper images of FIG. 7. If the two ratios are equal, the trigger fingertip is determined to be touching the function region, as shown in FIG. 6 and the two lower images of FIG. 7, and then the function corresponding to the function region is outputted.

In the present invention, when two or more numerical values are compared, values deviated within a threshold range are still considered the same, equal, or consistent. A general threshold value for tolerance may be set as around Z/5d.

As the field of views (FOVs) captured by different cameras are different, an X-axis pixel value X acquired by the human hand joint detection model can be directly converted into 6 radian/angle in all the above formulas. Assuming that a total resolution of the X-axis of an image is 1800 pixels, the FOV of a corresponding camera is 180 degrees, and the X-axis pixel value X of (X, Y) of the target point T fed back by the human hand joint detection model is pixel 900, then the θ radian of the target point is π/2 (the angle is 90). As the present invention only needs to compare relative radian ratios formed by three target points (WL, P, WR) of the images of the left and right (plurality of) cameras, the relative radian ratios formed by the three target points T can be calculated directly by using the X-axis pixel value X of the target point T fed back by the human hand joint detection model without the need to convert an absolute θ radian or angle. Therefore, assuming that 6 is the X-axis pixel value X outputted by the human hand joint detection model, the radian ratio of the left image is (PX_{L}−WRX_{L}):(WLX_{L}−PX_{L}), and the radian ratio of the right image is (PX_{R}−WRX_{R}):(WLX_{R}−PX_{R})
(6) Examples of arrangements of function regions on the palm:

FIG. 8 is an example of an arrangement of function regions in form of a numeric pad on a palm, where virtual typing can be achieved by tapping different areas of the palm.

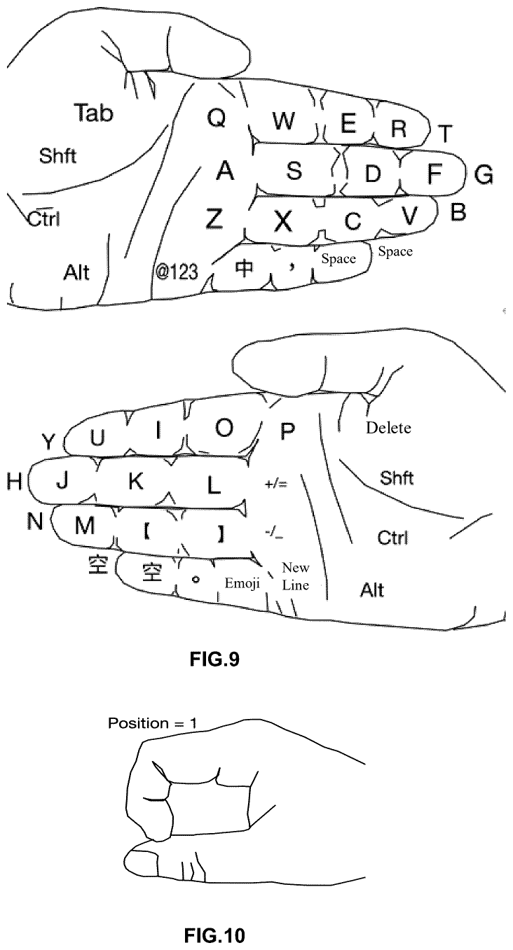

FIG. 9 is an example of an arrangement of function regions on both palms in form a conventional QWERTY keyboard, where virtual typing can be achieved by tapping different areas of both palms.

By adopting the technical solutions of the present invention, the position of each function region and the corresponding character (or function key/shortcut key) assigned to the function region can be set by a user based on typing habit and convenience of use. As long as the function region is set at a joint of the palm or any position of a joint line between two adjacent joints of the palm, the positional information of the function region can be obtained from the positional information of the joint points bearing a time sequence as outputted by the human hand joint detection model, and the positional information of the two trigger determination points corresponding to the function region can also be obtained, such that whether the trigger fingertip touches the function region can be determined.
(7) Principles of implementing touch control on the palm center:

As the images captured by a camera has two dimensional pixel data (X and Y), the present invention can implement two dimensional touch control functions on a planar surface of the palm center, such as drawing, writing, dragging, pulling, and other two-dimensional actions.

According to a system of the present invention, a matrix grid (which may be visible or invisible) is virtually assigned to a same position on the palm center on a viewer's screen of each camera of the intelligent glasses. A left hand being an illustrative example is shown in FIG. 17, where a connection point between the little finger and the palm center is determined as an upper right corner of the matrix grid, a connection point of the index finger and the palm center is determined as an upper left corner of the matrix grid, and a connection line between the palm center and the wrist is determined as a bottom edge of the matrix grid. When the palm rotates and moves, a position of the matrix grid is always fixed relative to the palm center because the matrix grid is fixed to the joint points of the palm. Each grid unit of the matrix grid has four lines corresponding to four sides which are top, bottom, left, and right sides. The matrix grid is not limited to a square shape but may have any shape, for example, a triangular matrix grid has three sides, and a hexagonal matrix grid has six sides. Alternatively, the matrix grid may have an irregular shape, where grid units of the irregular matrix grid may have different numbers of sides or different patterns, and each of the grid units may be regarded as a corresponding function region, and the “method for determining whether the trigger fingertip touches the function region” as mentioned in the above point (5) can be used to determine whether the trigger fingertip touches the function region.

According to the system of the present invention, the trigger fingertip P (X, Y) is tracked and determined whether it is located in a same function region of the matrix grid as tracked and determined by both the left and right (or a plurality of) cameras, and then the trigger fingertip P (X, Y) and left and right sides of the function region are determined as three target points T (the left trigger determination point WL, the trigger fingertip P, and the right trigger determination point WR). X-axis values (WRX, PX, and WLX) of the positional information of the three target points T are used to calculate a ratio (PX−WRX):(WLX−PX)(difference in value between PX and WRX to difference in value between WLX and PX). If ratios of corresponding images determined by all cameras are equal, the trigger fingertip P is determined to have touched the function region, and so a point or stroke is drawn corresponding to a position of the trigger fingertip P, and as the trigger fingertip P moves, series of determinations by the system through time bearing a time sequence will determine points or strokes successively drawn in successive locations through time and thus determine that a line is drawn where all points or strokes being drawn are determined to be joined together. Therefore, the functions of drawing, writing, and dragging can be implemented in the palm of one hand by using one fingertip of another hand as the trigger fingertip, just like implementing touch control function on a tablet or a touch screen. Further, the touch control function of a tablet or a touch screen with multiple fingers may also be implemented by using multiple trigger fingertips. Also, a three-dimensional point or stroke P (X, Y, Z) may also be drawn by calculating a depth Z of the trigger fingertip by trigonometry, wherein the formulae of radian ratios are consistent with what have been disclosed earlier above, where a ratio of radian-converted pixel in the left image (of the left camera) is (PX_{L}−WRX_{L}):(WLX_{L}−PX_{L}), and a ratio of radian-converted pixel in the right image (of the right camera) is (PX_{R}−WRX_{R}):(WLX_{R}−PX_{R}); if there are N cameras (N is an integer and N≥2), the radian ratios (PX_{N}−WRX_{N}):(WLX_{N}−PX_{N}) of all the cameras are required to be the same (or within a preset threshold deviation) to determine an actual touch, otherwise, there is no touch.

It should be noted that as the palm can rotate at will, the corresponding matrix grid also rotates along with the palm. Therefore, when the trigger fingertip is in a same grid unit (function region) determined by, for example, a left camera and a right camera, values of WLX and WRX on left and right sides may change in real time given the same height Y being unchanged, so the calculation for confirming the touch according to the present invention has to perform a comparison of corresponding images bearing a same time.

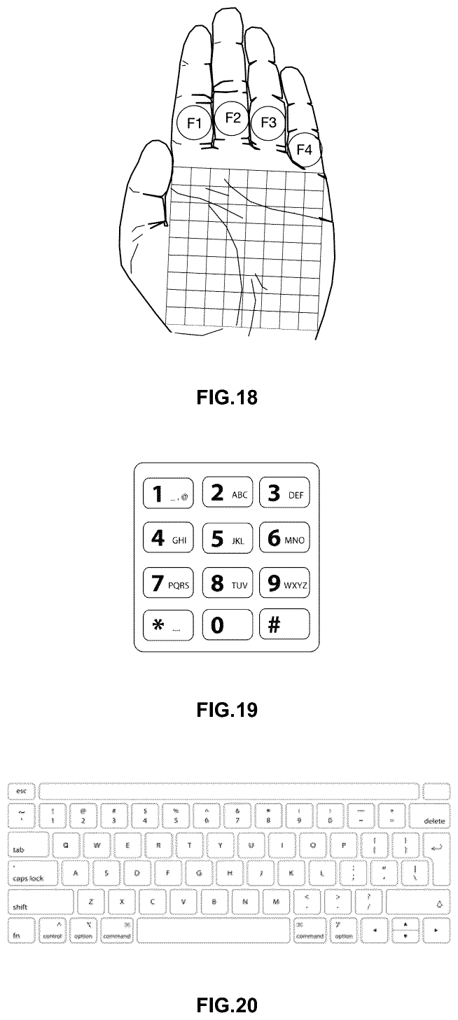

FIG. 18 is a schematic diagram of an XY matrix grid displayed in a palm center and shortcut keys displayed in phalangeal regions, thus integrating the functions of tablet touch control and shortcut keys.
(8) As the existing intelligent glasses are provided with IMU chips, 1/3/6 degrees of freedom (1/3/6DoF) can be used to anchor any image at a fixed position in a three-dimensional space around the user. Apart from using palm-anchored keyboards and numeric pads, the present invention can also allow typing and touch control outside the palm. FIG. 19 shows an image of a simple numeric pad anchored to an object surface, such as a wall or a desk. FIG. 20 shows an image of a keyboard, which can be anchored to a wall or a desk in the same manner for use. The object surface may be an irregular surface. According to the present invention, video streams of images with a parallax are acquired through at least two cameras of the intelligent glasses. When it is seen from said at least two cameras that the trigger fingertip enters a function region, a relative positional relationship between the position of the trigger fingertip and two trigger determination points corresponding to the function region is being determined for all corresponding images from all the cameras bearing a same time. If the relative positional relationships of the three target points are consistent in said all corresponding images acquired by all the cameras, it is determined that the trigger fingertip has touched the function region; otherwise, the trigger fingertip has not touched the function region. As such, a user touches a real object surface during typing or touch control instead of performing touch control on a virtual button in the air, thereby achieving tactile feedback during typing or touch control.

The object surface may also be a surface of a virtual object, and when the trigger fingertip touches the function region, feedback like sound, vibration, electric shock, or other mechanical feedback can be provided to the user to create a sense of touching a real object.

The present invention further comprises different depth and speed sensors which can be used together with conventional camera sensors or used independently. As the present invention relies on the relative positional relationship between the trigger fingertip and the two trigger determination points to determine whether there is an actual touch, computation of trigonometric calculation of a depth position shall not be required; however, monitoring and implementation can be achieved by the present invention based on relative distances and ratios of the positions of three target points obtained through depth sensors such as laser SLAM, IR tracking, and motion sensors. For example, a motion velocity sensor outputs a moving pixel, which can be utilized by the present invention. The SLAM, while providing an Z value for each X-axis pixel, can also provide an X value. The IR sensor and other time of flight (ToF) sensors, while providing the depth Z value, can also provide X and Y values for calculation by the present invention.

The present invention is not only suitable for typing on the palm, but also suitable for any interactive instructions that need to be combined with typing or touch control on the palm. For example, the user may perform the following actions:

A. A ray is projected along a designated anchoring position from a designated launching position of a hand, where when the ray points to a target position which is a virtual key or a link at a certain distance away from the user, the cooperative touch control instruction by tapping the palm (including the fingers and their phalangeal regions) using the trigger fingertip can be executed according to the method of the present invention.

B. When the user taps a virtual screen or a virtual button link by the index finger, a short-press instruction or a long-press instruction may be cooperatively required through triggering a virtual key, for example, by tapping a distal phalangeal region of the middle finger by the tip of the thumb, and thus the cooperative touch control instruction by tapping the palm (including the fingers and their phalangeal regions) using the trigger fingertip can be executed according to the method of the present invention.

C. Some intelligent glasses are equipped with eyeball trackers to determine which angle the user is looking at according to the angle of pupils of the left and right eyes so as to project a ray three-dimensionally; when the ray points to a target position which is a virtual key or a function region corresponding to a link at a certain distance away from the user, the cooperative touch control instruction by tapping the palm (including the fingers and their phalangeal regions) using the trigger fingertip can be executed according to the method of the present invention.

D. Some intelligent glasses projects a ray three-dimensionally perpendicular to a center position of the glasses; when the ray points to a target position which is a virtual key or a function region corresponding to a link at a certain distance away from the user, the cooperative touch control instruction by tapping the palm (including the fingers and their phalangeal regions) using the trigger fingertip can be executed according to the method of the present invention.

### Embodiment 1

Embodiment 1 of the present invention relates to a method for achieving typing or touch control with tactile feedback, applicable to a system with an extended reality (XR) wearable device or particularly an extended reality headset; wherein the system outputs positional information, which bears a time sequence, of joint points of a human hand captured in a video of each camera of the system through a human hand joint detection model. As defined herein, a “palm” is meant to include both palm and fingers; typing and touch control is achieved by touching function regions by a trigger fingertip; said method comprises the following steps.

Step 1, mark a preset point on a joint line of each of every two adjacent joints of the palm, wherein user is capable of visually perceiving a corresponding function region assigned to each preset point on the palm through a pair of intelligent glasses, and each function region is a character button, function key, or shortcut key that is capable of being triggered; set a width of each function region as W, a corresponding preset point of each function region is determined as a central point of that function region, and set two trigger determination points WL and WR at positions W/2 to the left and W/2 to the right of the central point respectively along a direction parallel to an X-axis; determine the positional information of each preset point and the two trigger determination points WL and WR of the corresponding function region assigned to each preset point based on the joint points;

each function region is formed as any shape; preferably, each function region has a circular shape; a circle is drawn with a preset point set at any position on the joint line between two adjacent joints as a center of circle and the width W of the function region as a diameter.

The present invention can assign each function region within a phalangeal region, between two phalangeal regions, on an outer side of a phalangeal region, or at a certain area of a palm center between the wrist and a certain finger.

Step 2: consider a tip of a thumb to be the trigger fingertip by default; if the thumb does not access to areas on the palm, a tip of any one of other fingers intended to touch the palm is determined as the trigger fingertip;

Step 3, the system acquires N number of video streams with parallax from at least two cameras, track and determine whether the trigger fingertip P is located between the two trigger determination points WL and WR corresponding to left and right sides of a corresponding function region respectively in all corresponding N number of images bearing a same time from said N number of video streams respectively, and if yes, X-axis values (WRX, PX, and WLX) of positional information of three target points T (a left trigger determination point WL of the two trigger determination points, the trigger fingertip P, and a right trigger determination point WR of the two trigger determination points) of each of said N number of images are used to calculate a ratio (PX−WRX):(WLX−PX) which is a difference in value between PX and WRX to a difference in value between WLX and PX; only when all ratios in said N number of images are the same, the trigger fingertip P is determined to have touched the function region, and then a function corresponding to the function region is outputted or triggered.

Said at least two cameras comprises two cameras being a left camera and a right camera; treating a connecting line passing through central points L and R of both the left camera and the right camera as an X-axis; assuming that in a field of vision of the left camera, an included angle defined as TθL, is formed between the X-axis and a connecting line connecting the central point L of the left camera and one of the three target points T; similarly; assuming that in a field of vision of the right camera, an included angle defined as TθR, is formed between the X-axis and a connecting line connecting the central point R of the right camera and one of the three target points T; assuming a length of a parallax baseline between the two central points L and R of the left camera and the right camera as d; calculate a position (X, Z) of any one of the three target points T based on the following:

If the target point T whose position is to be calculated is located between the two central points L and R of the left camera and the right camera:

$$Z = d / [ TAN ( T θ L ) - TAN ( T θ R - π / 2 ) ] , X = Z * TAN ( T θ L ) ;$$

If the target point T whose position is to be calculated is located on a left side of the central point L of the left camera:

$$Z = d / [ TAN ( T θ R - π / 2 ) - TAN ( T θ L - π / 2 ) ] , X = - Z * TAN ( T θ L ) ;$$

If the target point T whose position is to be calculated is located on a right side of the central point R of the right camera:

$$Z = d / [ COT ( T θ L ) - COT ( T θ R ) ] , X = Z / Tan ( T θ L ) .$$

The system virtually assigns a matrix grid to a same position on a palm center captured on at least two viewer's screens corresponding to left and right eyes of a user; a connection point between a little finger and the palm center is determined as an upper right corner of the matrix grid, a connection point of an index finger and the palm center is determined as an upper left corner of the matrix grid, and a connection line between the palm center and the wrist is determined as a bottom edge of the matrix grid; the matrix grid comprises a plurality of uniformly arranged grid units each has a plurality of sides, and each grid unit is considered as a function region; the system tracks and determines whether the trigger fingertip P (X, Y) is located in a same function region of the matrix grid in said at least two viewer's screens, and if yes, the trigger fingertip P (X, Y) and the two trigger determination points corresponding to the function region in concern are determined as the three target points T (the left trigger determination point WL, the trigger fingertip P, and the right trigger determination point WR); then the X-axis values (WRX, PX, and WLX) of the positional information of the three target points T are used to calculate a ratio (PX−WRX):(WLX−PX) which is a difference in value between PX and WRX to a difference in value between WLX and PX; If ratios of all corresponding images bearing a same time in said at least two viewer's screens are equal, the trigger fingertip is determined to have touched the function region, and so a point or stroke is drawn corresponding to a position of the trigger fingertip P (X, Y), and as the trigger fingertip P moves, series of determinations by the system through time bearing a time sequence will determine points or strokes successively drawn in successive locations through time and thus determine that a line is drawn where all points or strokes being drawn are determined to be joined together. Therefore, the functions of tablet control or touch control can be implemented in the palm of one hand by using one fingertip of another hand as the trigger fingertip.

The matrix grid is invisible and not displayed on said at least two viewer's screens.

The present invention also discloses another method for achieving typing or touch control with tactile feedback, applicable to a system with an extended reality (XR) wearable device or particularly an extended reality headset; the system outputs positional information, bearing a time sequence, of target points captured by videos, and achieving typing and touch control by touching function regions using a trigger fingertip; said method comprises the following steps.

Step 1, the system anchors a touch control interface image on each viewer's screens respectively at a same position of a same preset object surface; a plurality of function regions are assigned on the touch control interface image as viewed from any one of the N number of viewer's screens; corresponding images from all the videos bearing a same time are each being determined to have a left trigger determination point WL and a right trigger determination point WR at left and right sides of a corresponding function region in concern respectively along a direction parallel to an X-axis of the image from a corresponding video.

Step 2, a tip of any finger intended to touch the function regions is determined as a trigger fingertip P.

Step 3, the system acquires N number of video streams with parallax from N number of cameras, where N is an integer, and; track and determine whether the trigger fingertip P (X, Y) is located in a same function region in all corresponding N number of images bearing a same time from said N number of video streams respectively, and if yes, the trigger fingertip P (X, Y) and the left trigger determination point WL and the right trigger determination point WR corresponding to the function region in concern are used as three target points; X-axis values (WRX, PX, and WLX) in the positional information of the three target points are used to calculate a ratio (PX−WRX):(WLX−PX) which is a difference in value between PX and WRX to a difference in value between WLX and PX; only when all ratios in said N number of images are the same, the trigger fingertip P is determined to have touched the function region, and then a function corresponding to the function region is outputted or triggered.

The touch control interface image is an image of a conventional numeric pad or a conventional keyboard.

The preset object surface is a wall surface, a desk surface, or the like.

Those skilled in the art should further appreciate that portions and algorithm steps of various examples described with reference to the embodiments disclosed herein can be implemented through electronic hardware, computer software, or a combination thereof. In order to clearly illustrate the interchangeability of implementation through hardware and software, the components and steps of various examples have been generally described in terms of their operative features in the above description. Whether these features are performed through hardware or software depends on the constraints and conditions of the technical solutions proposed in the context of a particular utilization or design. Those skilled in the art may implement the described features in various ways for each particular example of utilization, and such various ways of implementation are not to be considered exceeding the scope of the present invention.

Specifically, the steps of the method disclosed in the embodiments of the present application may be performed through a processor by hardware integrated logic circuits and/or software commands. The steps of the method disclosed with reference to the embodiments of the present application may be directly embodied as being performed by a hardware coding processor, or performed by a combination of hardware and software modules in the coding processor. Optionally, the software modules may be located in well-known storage medium in the art, such as a random access memory, a flash memory, a read-only memory, a programmable read-only memory, an electrically erasable programmable memory, or a register. The storage medium is located in a storage device; the processor reads information in the storage device and implements the method steps of the above embodiments in combination with the hardware of the processor.

### Embodiment 2

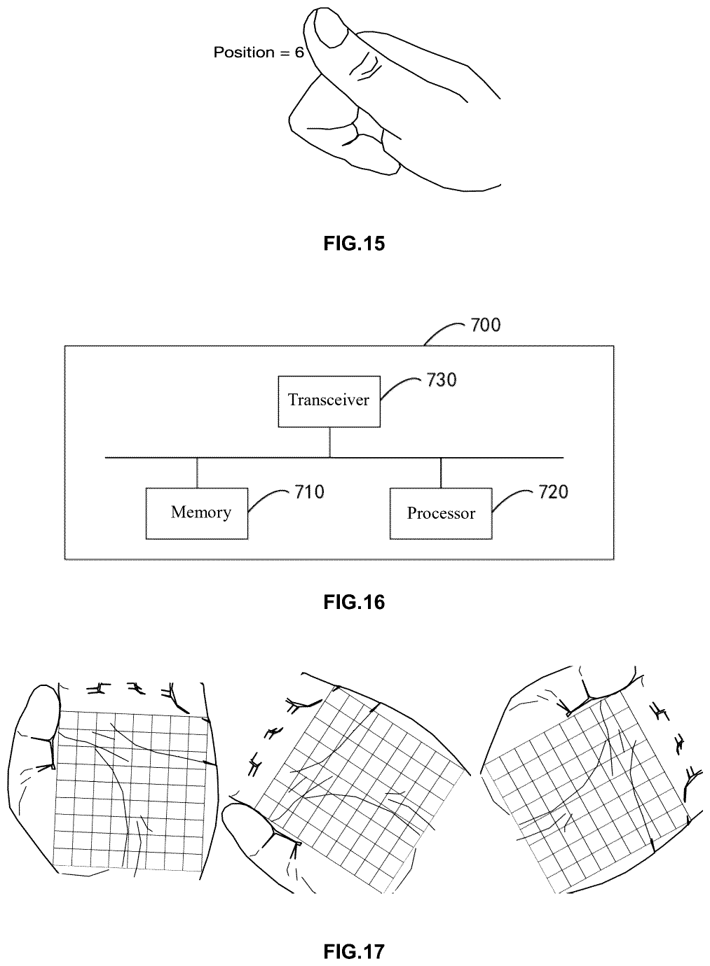

Embodiment 2 of the present invention provides a head-mounted display device. As shown in FIG. 16, the head-mounted display device 700 comprises: a memory 710 and a processor 720; wherein the memory 710 is configured to store a computer program and transmit program codes to the processor 720. In other words, the processor 720 can call and run the computer program from the memory 710 to perform the methods in the embodiments of the present application. For example, the processor 720 can be configured to perform the processing steps in the method described according to an embodiment of the present invention based on commands configured in the computer program.

In some embodiments of the present application, the computer program can be divided into one or more modules, and said one or more modules are stored in the memory 710 and executed by the processor 720 to perform the method of an embodiment provided by the present application. Said one or more modules may be a series of computer program command segments capable of performing specific functions, and the command segments are defined to describe the execution of the computer program on the head-mounted display device 700.

As shown in FIG. 16, the head-mounted display device further comprises a transceiver 730, which is connected to the processor 720 or the memory 710. The processor 720 can control the transceiver 730 to communicate with other devices, specifically, to send information or data to other devices, or to receive information or data sent from other devices. The transceiver 730 may be at least two cameras configured to take videos/images of a targeted region.

It should be appreciated that the various components in the head-mounted display device 700 are connected through a bus system, where the bus system includes a power bus, a control bus, and a status signal bus in addition to a data bus.

The above specific embodiments further illustrate the objects, technical solutions, and beneficial effects of the present invention, and it should be appreciated that the above description shows only specific embodiments of the present invention and is not intended to limit the protection scope of the present invention. Any modification, equivalent configurations, improvement, and the like made without departing from the essence and principle of the present invention shall fall within the protection scope of the present invention.

What is claimed is:

1. A method for achieving typing or touch control with tactile feedback, implemented through a system configured in an extended reality wearable device or an extended reality headset; wherein the system outputs positional information, which bears a time sequence, of joint points of a human hand captured in a video stream of each camera of the system through a human hand joint detection model; characterized in that:
typing and touch control is achieved through a trigger fingertip touching function regions assigned virtually on a palm of the human hand, wherein the palm is defined to include both a palm center without fingers, and also the fingers; each of the function regions is a character or number button, function key, or shortcut key that is capable of being triggered; and a corresponding function region is assigned and fixed to a preset point marked on a virtual joint line of each of every two adjacent joints of the palm; said method comprises the following steps:
Step 1: mark the preset point on the virtual joint line of each of every two adjacent joints of the palm, wherein the corresponding function region assigned to each preset point on the palm is capable of being visually perceived through a pair of intelligent glasses; set a width of each of the function regions as W; a corresponding preset point of each of the function regions is determined as a central point of that function region; set a left trigger determination point WL and a right trigger determination point WR at positions W/2 to the left and W/2 to the right of the central point of each of the function regions respectively along a direction parallel to an X-axis; determine the positional information of each preset point and the left trigger determination point WL and the right trigger determination point WR of the corresponding function region assigned to each preset point based on the joint points;
Step 2: consider by default a tip of a thumb to be the trigger fingertip; if the thumb does not access to areas on the palm, but a tip of any one of other fingers is intended to touch the palm and the function regions assigned to the palm, the tip of said any one of other fingers is determined as the trigger fingertip; the trigger fingertip is identified as P;
Step 3, the system acquires N number of video streams with parallax from at least two cameras, wherein N is an integer, and N≥2, track and determine whether the trigger fingertip P is located between the left trigger determination point WL and the right trigger determination point WR corresponding to left and right sides of a corresponding function region respectively in all corresponding N number of images bearing a same time from said N number of video streams respectively, and if yes, calculate the positional information of three target points which are the left trigger determination point WL, the trigger fingertip P, and the right trigger determination point WR for each of said N number of images bearing the same time; then in each of said N number of images bearing the same time, X-axis values, including WRX of the right trigger determination point WR, PX of the trigger fingertip P, and WLX of the left trigger determination point WL, of the positional information of the three target points in that image are used to calculate a ratio (PX−WRX):(WLX−PX) which is a difference in value between PX and WRX to a difference in value between WLX and PX; only when all ratios calculated in all of said N number of images bearing the same time are the same, the trigger fingertip P is determined to have touched the corresponding function region, and then a function corresponding to the corresponding function region is outputted or triggered.

2. The method of claim 1, wherein in the above Step 3, said at least two cameras comprises two cameras being a left camera and a right camera; treating a connecting line passing through two central points L and R of the left camera and the right camera respectively as the X-axis; assuming that in a field of vision of the left camera, an included angle defined as TθL is formed between the X-axis and a connecting line connecting the central point L of the left camera and one of the three target points T; assuming that in a field of vision of the right camera, an included angle defined as TθR is formed between the X-axis and a connecting line connecting the central point R of the right camera and one of the three target points T; assuming a length of a parallax baseline between the two central points L and R of the left camera and the right camera as d, calculate a position (X, Z) of any one of the three target points T in each of said N number of images bearing the same time based on the following:
if the target point T whose position is to be calculated is located between the two central points L and R of the left camera and the right camera:
$$Z = d / [ TAN ( T θ L ) - TAN ( T θ R - π / 2 ) ] , X = Z * TAN ( T θ L ) ;$$
if the target point T whose position is to be calculated is located on a left side of the central point L of the left camera:
$$Z = d / [ TAN ( T θ R - π / 2 ) - TAN ( T θ L - π / 2 ) ] , X = - Z * TAN ( T θ L ) ;$$
if the target point T whose position is to be calculated is located on a right side of the central point R of the right camera:
$$Z = d / [ COT ( T θ L ) - COT ( T θ R ) ] , X = Z / Tan ( T θ L ) .$$

3. The method of claim 1, wherein each of the function regions has a circular shape; a circle is drawn for each of the function regions with the preset point set at any position on the joint line between each of every two adjacent joints of the palm as a center of circle and the width W of each of the function regions as a diameter.

4. The method of claim 1, wherein each of the function regions is assigned within a phalangeal region, between two phalangeal regions, on an outer side of the phalangeal region, or at a certain area of the palm center between a wrist and a certain finger.

5. The method of claim 1, wherein in the above Step 3, the system virtually assigns a matrix grid to a same position on the palm center when N number of video streams are processed, wherein N is an integer, and N≥2; the matrix grid comprises a plurality of grid units each having a plurality of sides, and each grid unit is considered as one function region; the system tracks and determines whether the trigger fingertip P (X, Y) is located in a same function region of the matrix grid in all of said N number of viewer's screens, and if yes, the trigger fingertip P (X, Y) and the left trigger determination point WL and the right trigger determination point WR to left and right sides of the function region in concern are determined as the three target points T; then X-axis values, including WRX of the right trigger determination point WR, PX of the trigger fingertip P, and WLX of the left trigger determination point WL, of the positional information of the three target points are used to calculate a ratio (PX−WRX):(WLX−PX) which is a difference in value between PX and WRX to a difference in value between WLX and PX; if ratios calculated in all corresponding images bearing a same time in said N number of video streams are equal, the trigger fingertip P is determined to have touched the function region, and so a point or stroke is drawn corresponding to a position of the trigger fingertip P (X, Y), and as the trigger fingertip P moves, series of determinations by the system through time bearing a time sequence will determine points or strokes successively drawn in successive locations through time and thus determine that a line is drawn where all points or strokes being drawn are determined to be joined together; therefore, functions of tablet control or touch control can be implemented in the palm of one hand by using one fingertip of another hand as the trigger fingertip.

6. The method of claim 5, wherein a connection point between a little finger and the palm center is determined as an upper right corner of the matrix grid; a connection point of an index finger and the palm center is determined as an upper left corner of the matrix grid; and a connection line between the palm center and a wrist is determined as a bottom edge of the matrix grid.

7. The method of claim 5, wherein the matrix grid is invisible and not displayed on said N number of viewer's screens.

8. The method of claim 5, wherein each grid unit has a square or rectangular shape.

9. A method for achieving typing or touch control with tactile feedback, implemented through a system configured in an extended reality wearable device or an extended reality headset; the system outputs positional information, bearing a time sequence, of target points captured by videos; typing and touch control is achieved by a trigger fingertip touching function regions; said method comprises the following steps:
Step 1, the system anchors a touch control interface image on each screen at a same position of a same preset object surface; a plurality of said function regions are assigned on the touch control interface image as viewed from any one of the N number of viewer's screens; corresponding images from all the videos bearing a same time are each being determined to have a left trigger determination point WL and a right trigger determination point WR at left and right sides of a corresponding function region in concern respectively along a direction parallel to an X-axis of the image from a corresponding video;
Step 2, a tip of any finger intended to touch the function regions is determined as the trigger fingertip P;
Step 3, the system acquires N number of video streams with parallax, where N is an integer, and N≥2; track and determine whether the trigger fingertip P (X, Y) is located in a same function region in all corresponding N number of images bearing a same time from said N number of video streams respectively, and if yes, the trigger fingertip P (X, Y) and the left trigger determination point WL and the right trigger determination point WR corresponding to the function region in concern are used as three target points T; X-axis values, including WRX of the right trigger determination point WR, PX of the trigger fingertip T, and WLX of the left trigger determination point WL, in the positional information of the three target points T are used to calculate a ratio (PX−WRX):(WLX−PX) which is a difference in value between PX and WRX to a difference in value between WLX and PX; only when all ratios in said N number of images bearing the same time are the same, the trigger fingertip P is determined to have touched the function region, and then a function corresponding to the function region is outputted or triggered.

10. The method of claim 9, wherein the touch control interface image is an image of a conventional numeric pad or a conventional keyboard.

11. The method of claim 9, wherein the preset object surface is any surface of a real object.

12. The method of claim 9, wherein the preset object surface is a surface of a virtual object, and when the trigger fingertip touches a corresponding function region, feedback in form of sound, vibration, electric shock, or other mechanical feedback is provided to create a sense of touching a real object.

13. A head-mounted display device, comprising at least two cameras configured to take videos or images of a targeted region; the head-mounted display device also comprises a memory and a processor; the memory is configured to store a computer program; the processor executes the computer program to perform the method of claim 1.

14. A head-mounted display device, comprising at least two cameras configured to take videos or images of a targeted region; the head-mounted display device also comprises a memory and a processor; the memory is configured to store a computer program; the processor executes the computer program to perform the method of claim 9.
